(19) United States
(12) Patent Application Publication
(10) Pub. No.: US 2023/0243110 A1
(43) Pub. Date: Aug. 3, 2023

(54) COMPOSTABLE ARTIFICIAL TURF INFILL

(71) Applicant: Melos GmbH, Melle (DE)

(72) Inventors: Sascha SEIFERT, Bunde (DE); Melina PLACKE, Wallenhorst (DE)

(73) Assignee: Melos GmbH, Melle (DE)

(21) Appl. No.: 18/004,544

(22) PCT Filed: Jul. 9, 2021
(86) PCT No.: PCT/EP2021/069123

§ 371 Date: Jan. 6, 2023

(30) Foreign Application Priority Data
Jul. 10, 2020 (EP) 20185337.1

(51) Int. Cl. E01C 13/08; C08L 67/02; C08L 67/04

(52) U.S. Cl. CPC E01C 13/08; C08L 67/02; C08L 67/04; C08L 2205/02; C08L 2207/04

(57) ABSTRACT

The invention provides for an artificial turf infill (602) for an artificial turf, wherein the artificial turf infill consists of granules (101), wherein the granules are made from unfoamed material, wherein the granules comprise
a compostable polymer selected from the group consisting of polylactic acid (PLA), thermoplastic copolyester elastomer (TPC), polybutylene succinate (PBS), poly(3-hydroxybutyrate-co-3-hydroxyvalerate) (PHBV), polyhydroxybutyrate (PHB), polyhydroxyalkanoate (PHA), polybutylene adipate terephthalate (PBAT), a derivative thereof or a mixture thereof;
a filler material; and
an oil.

### FIELD OF THE INVENTION

The invention relates to a compostable artificial turf infill for an artificial turf and an artificial turf with a compostable artificial turf infill.

### BACKGROUND AND RELATED ART

Artificial turf or artificial grass is surface that is made up of fibers that is used to replace grass. The structure of the artificial turf is designed such that the artificial turf has an appearance which resembles grass. Typically artificial turf is used as a surface for sports such as soccer, American football, rugby, tennis, golf, for playing fields, or exercise fields. Furthermore artificial turf is frequently used for landscaping applications.

Artificial turf may be manufactured using techniques for manufacturing carpets. For example, artificial turf fibers that have the appearance of grass blades may be tufted or attached to a backing. Often times artificial turf infill is placed between the artificial turf fibers.

Artificial turf infill is a granular material that covers the bottom portion of the artificial turf fibers. The use of artificial turf infill may have a number of advantages. For example, artificial turf infill may help the artificial turf fibers stand up straight. Artificial turf infill may also absorb impact from walking or running and provide an experience similar to being on real turf. The artificial turf infill may also help to keep the artificial turf carpet flat and in place by weighting it down.

Even though the artificial turf infills known from the art are constantly being further developed, rubber granulate or recycled (e.g., from car tires) rubber granulate has been used most commonly as artificial turf infill. The most commonly used rubbers are styrene-butadiene rubber (SBR) and ethylene propylene diene monomer (EPDM), both of which can be generated from recycled rubber (post-consumer waste or post-industrial waste) or virgin material. Recycled rubbers are cost-effective as they are derived from existing products that have reached the end of their service life. Even though recycling of, e.g., used car tires to make artificial turf infill particles has an environmentally friendly aspect, concerns have arisen lately about the potential health effects of substances released by the granulate in synthetic turf sports fields with vulcanized (either by peroxide or sulfur vulcanization) recycled rubber infill. Another negative side effect of the use of rubber as artificial turf infill is that in the hot season, when the outside surfaces are subjected to severe heat, rubber-based artificial turf infill materials tend to heat to 20-40° C. above the ambient temperature. As a result, the artificial turf is perceived as unpleasantly hot by the player.

Further, concerns have arisen lately as artificial turf infill from artificial grass playing fields can be released by means of wind and rain, through general maintenance, rubbish disposal, surface water drains and players' clothing. The concern is that the escaped hitherto used artificial turf infill granulate, which is very resistant to normal environmental degradation, and which will lead to it being present in the environment for a long time after its initial release, affects soil, waterways and ultimately the ocean. Thus, the hitherto used artificial turf infill granulate may be considered as microplastics pollution. Microplastics are defined as very small (typically smaller than 5 mm) solid particles composed of mixtures of polymers (the primary components of plastics) and functional additives. They may also contain residual impurities from when they were manufactured. In the EU/EAA it is estimated that up to 16 000 tonnes of infill material used in artificial turfs may be released per year (https://echa.europa.eu/de/hot-topics/microplastics).

It is therefore the purpose of the invention to provide an improved turf infill material which is environmentally friendly.

### SUMMARY

The invention provides for an artificial turf infill, a method of manufacturing an artificial turf infill, an artificial turf, and a method for manufacturing an artificial turf in the independent claims. Embodiments are given in the dependent claims. Embodiments and examples described herein can freely be combined if they are not mutually exclusive.

In one aspect the invention provides for an artificial turf infill for an artificial turf. The artificial turf infill consists of granules, in particular compostable granules. The granules are made from unfoamed material. The granules of the artificial turf infill comprise
a compostable, in particular biodegradable, polymer selected from the group consisting of polylactic acid (PLA), thermoplastic copolyester elastomer (TPC), polybutylene succinate (PBS), poly(3-hydroxybutyrate-co-3-hydroxyvalerate) (PHBV), polyhydroxybutyrate (PHB), polyhydroxyalkanoate (PHA), a derivative thereof or a mixture thereof,
a filler material, and
an oil.

In a beneficial aspect, the granules are made from unfoamed material, meaning no gas bubbles are intentionally trapped in pockets. It is further envisioned that the granules are devoid of any blowing agent, which might be environmentally unfriendly. By avoiding the use of any blowing agent during the manufacture of the artificial turf infill, the material density of the granules components comprised in the granules of the artificial turf infill, here at least one compostable polymer, a filler material and an oil, may thus be at least 0.8 g/cm³. As the density of the granules may be at least 0.8 g/cm³, the artificial turf infill may not easily be blown away under windy conditions. It is further conceivable that the density of the granules may be higher than 1.0 g/cm³, making it even more difficult for the granules to escape due to wind or rain.

As the turf infill comprises a compostable, in particular biodegradable, polymer selected from the group consisting of polylactic acid (PLA), thermoplastic copolyester elastomer (TPC), polybutylene succinate (PBS), poly(3-hydroxybutyrate-co-3-hydroxyvalerate) (PHBV), polyhydroxybutyrate (PHB), polyhydroxyalkanoate (PHA), polybutylene adipate terephthalate (PBAT), a derivative thereof or a mixture (blend) thereof, a filler material (obtained from natural sources) and an (biodegradable) oil, the artificial turf infill is fully compostable.

It is within the scope of the invention that the artificial turf infill conforms with the strict criteria of the European norm DIN EN 13432 on industrial compostability.

Artificial turf infills have an expected lifetime of about of 10-15 years, after which the infill material show signs of material fatigue due to constant mechanical stress and chemical/environmental impact. Furthermore, the infill may lose their color and may bleach. Thus, as the granules are made of compostable materials, the artificial turf infill of the invention can be composted after its service life. It is thus conceivable that the used infill may be transported from the place of use and decomposed in an industrial composting plant, where conditions (e.g. temperature, humidity, aeration) are controlled. Microbes, like bacteria or fungi and their enzymes, are able to “digest” the chain structure of compostable polymers as a source of nutrition. The resulting end products are water, carbon dioxide (CO₂) and biomass. Hereby, the speed of biodegradation depends on the temperature (usually 58° C.+/−2° C. composting process), humidity (water is required for the process), and the number and types of microbes. In industrial composting facilities, all those requirements are controlled and thus the artificial turf infill may be converted into CO₂, water and biomass, usually within 12 to 16 weeks.

In a further beneficial aspect, the artificial turf infill further comprises filler material. The filler material is homogeneously distributed in the granule. The use of filler material, in particular filler material from natural sources, such as e.g. barium sulfate, calcium carbonate, china clay, talc, aluminosilicate, and combinations thereof, can be advantageous, as the filler material particles are able to increase the overall material density of the granules. Thus, as the weight of the granules (granulate) increases, the risk of granules floating away during heavy rainfall or being blown away by strong wind is further reduced. According to some embodiments, the granules of the artificial turf infill have a density, in particular material density, of at least 1.0 g/cm³. According to some embodiments, it may be further beneficial that the granules may comprise up to 50 wt. % of filler material. Further, according so some embodiments, it may be beneficial that the filler material has a density of at least 2.0 g/cm³ and comprises any one of the following: barium sulfate, calcium carbonate, china clay, talc, aluminosilicate, and combinations thereof.

In a beneficial aspect, the granules of the artificial turf infill comprise elastic properties. Applicant has observed that the granules are elastic, as the combination of the compostable polymer selected from the group consisting of polylactic acid (PLA), thermoplastic copolyester elastomer (TPC), polybutylene succinate (PBS), poly(3-hydroxybutyrate-co-3-hydroxyvalerate) (PHBV), polyhydroxybutyrate (PHB), polyhydroxyalkanoate (PHA), polybutylene adipate terephthalate (PBAT), a derivative thereof or a mixture or a blend thereof, with the filler material and the oil showed stretching of polymer chains when forces were applied. Further, in a beneficial aspect, the granules of the artificial turf infill showed compression resilient properties and viscoelastic properties.

In a further beneficial aspect, the artificial turf infill further comprises an oil. The oil is mixed with the polymer and filler material during the manufacture of the granules and is therefore homogeneously distributed in the granules. The oil serves as a plasticizer, thereby making the granules softer and further increasing their elasticity. The presence of the oil may therefore increase the robustness of the infill granules against abrasion and against damages induced by multiple freeze-thaw-cycles: if inelastic filling material is pressed by water which expands its volume in a freezing process against another inelastic infill material, the infill material will be damaged. Thus, the presence of the oil may protect the infill granules from this effect.

The oil may be a biodegradable oil. Further, the oil may comprise an unsaturated ester, in particular an unsaturated synthetic ester. As the ester is unsaturated, the ester is enzymatically vulnerable and thus biodegradable. Further, the oil may be made from renewable resources. Suitable carbon sources for the oil made of renewable sources may be a manufacturing process or any other natural or man-made material or process that can be used to produce the desired substance. The oil may be made of renewable resources, such as for example glycerol, fatty acids and esterification from fats. Any kind of carbon source that is used for producing a material whose ¹⁴C atom content is similar or basically identical to the ¹⁴C content of biomass of recently living organisms is referred to as renewable carbon source. Atmospheric CO₂ is the source of radioactive carbon C14. Fossil (petro-based) carbon sources comprise a lower amount of radioactive C14 isotopes and thus can be discerned from renewable (bio-based) carbon sources by performing an isotope analysis (radiocarbon dating). Roughly half of all ¹⁴C atoms decay after 5700 years.

Biodegradable oils are as such know in the prior art, such as loss lubricants (“Verlustschmierstoffe”) and chain saw oils (“Sägekettenöle”), that can spill into the environment without causing environmental harm. Surprisingly such biodegradable oils can be used for manufacturing granules.

According to some embodiments, the artificial turf infill does not comprise any UV stabilizers like hindered amine light stabilizer (HALS), UV absorbers and radical scavengers. Hence, even if some of the granules escape from the sports field, the granules would not pollute the environment in an environmentally unfriendly manner, as the granules are made of compostable materials, such as e.g., biodegradable polymers, natural filler material and a biodegradable oil. The escaped granules would thus be composted. This biodegradation, however, occurs at very low rate in comparison to composting in industrial composting plants, as not as many microbes, like bacteria or fungi and their enzymes, are present in the natural habitat.

For the artificial turf infill it may be feasible that
the compostable polymer comprises 25% to 50% of the granules by weight, in particular between 31% and 48% or between 34% and 46%,
the filler material comprises 30% to 50% of the granules by weight, in particular between 31% and 49.7% or between 40% and 49.7%, and
the oil comprises 1% to 9% of the granules by weight, in particular between 2.5% and 8%.

Applicant has observed that these compositions of the individual components (compostable polymer, filler material and oil) in the weight percentage ranges shown proved to be very promising. The granules manufactured with the described weight percent ranges of the components showed a tensile strength between 0.2 MPa and 11.0 MPa, an elongation at break between 0.1% and 70%, a surface hardness of smaller than Shore A 98 or smaller than Shore D 55 and a density between 1.2 g/cm³ and 1.8 g/cm³.

According to some embodiments, the granules of the artificial turf infill (and therefore the artificial turf infill itself, as the artificial turf infill consists of granules) further comprises natural fibers selected from the group consisting of burlap fibers, jute fibers, cotton fibers, wool fibers, hemp fibers, flax fibers, kenaf fibers, nettle fibers, sisal fibers, coconut fibers, walnut fibers, abacá fibers (the abacá plant is also known as Manila hemp), and combinations thereof.

It is envisioned that the natural fibers are homogeneously distributed in the granule. The use of natural fibers has several beneficial aspects. The natural fibers have a relatively high specific heat capacity in comparison to other materials which are commonly used for artificial turf infill. If the artificial turf is exposed to warm air or to sunlight the use of the natural fibers may help to reduce heating of the artificial turf and the artificial turf infill overall. This may make for a safer and more pleasant playing surface. Another potential advantage is that the natural fibers have a high water absorbance and therefore the capacity to hold large amounts of water. Before a game is played on the artificial turf it may be possible to spray or sprinkle water onto the artificial turf. During the period of the game water, which is contained in the natural fiber, may slowly evaporate helping to keep the entire artificial turf surface cool during a game. Another potential advantage is that the natural fiber may reduce the cost of the artificial turf infill. Natural fibers are a suitable infill material and can be used to reduce the amount of the polymer that is used. Further, applicant has observed that the presence of natural fibers further increases the elasticity and the compression resilient properties of the granules.

According to some embodiments, the natural fibers are selected from the group consisting of jute fibers, hemp fibers, kenaf fibers, sisal fibers, coconut fibers, walnut fibers, abacá fibers, and combinations thereof. For each of these fibers the lignin content is higher than 8.9 wt % of the total fiber.

The use of these lignocellulosic fibers for the granules of the artificial turf may be beneficial as the lignocellulosic fibers are widely available, they are biodegradable and they comprise good mechanical properties and may thus be used for the reinforcement of the granules. In addition, lignin plays an important part in antioxidant properties as a stabilizer because the phenolic hydroxyl groups can scavenge free radicals.

Further, as the granules of the artificial turf comprise the oil, the presence of the oil may reduce or eliminate the usually occurring hydrophilicity and strong crosslinking of lignocellulosic fibers, which, without the presence of oil, result in prevention of the compatibility with biopolymer matrices, thereby leading to poor interfacial adhesion and mechanical properties, as e.g. these bioplastics possess limited dimensional stability when exposed to moisture. Thus, the oil acts as a compatibilizer between the lignocellulosic fibers and the polymer, thereby preventing the separation or delamination between the fibers and polymer matrix.

Applicant has observed that the compostable polymer, the filler material, the oil and hemp fibers as natural fibers showed a good miscibility, which prevented immediate separation of the components after manufacture of the granules.

Hence, the granules of the artificial turf infill further may comprise natural fibers, in particular fibers an lignin content higher than 8.9 wt % of the total fiber or in particular hemp fibers, wherein the natural fibers comprise 2% to 30% of the granules by weight, in particular between 7% and 18%.

According to some embodiments, the natural fibers are at least partially embedded in the granules of the artificial turf infill. For this, the granules of the artificial turf infill may comprise a polymer portion. The polymer portion may comprise the compostable polymer, the filler material, and the oil. The natural fibers are at least partially embedded in the polymer portion.

Having the natural fibers embedded within the (polymer portion of) the granule may have the advantage that the natural fibers do not become unmixed with the rest of the artificial turf infill. For example if natural fibers and the polymer portion were mixed loosely together over a period of time and being exposed to rain and water, for example, the natural fiber (being less dense) may have a tendency to go on top of the polymer portion and separate out. Having the natural fiber at least partially embedded in the polymer portion may prevent this.

As disclosed above, the natural fibers are at least partially embedded in the granules. The fiber being only partially embedded in the granule can be effectively divided into two portions in the longitudinal direction of the fiber, wherein one portion of the fiber is embedded in the granule and another portion of the fiber is not embedded in the granule. In other words the other portion protrudes from the granule. As it is customary in the industry, the other portion protruding from the granule is called a dangling end. At least some of the portions protruding from the granules can be longer than their respective portions embedded in the granules. It is also conceivable that the fiber is embedded in the granule and portion of the fiber is exposed at the surface of the granule.

Portions of fibers which are not embedded in the granules or exposed at the surface of the granule can facilitate water absorption, because they are fully exposed to water or moisture. Water absorbed by the dangling end of the fiber which is not embedded in the granule or the exposed portion of the fiber can further spread into the rest of the fiber which is embedded in the granule e.g. due to capillary effect. Thus the exposed portions and/or the dangling ends of the fibers can facilitate water absorption. The exposed portion and/or dangling end can further facilitate water evaporation from the fiber as well because an entire surface of the exposed portion and/or dangling end is exposed to air. Moreover the embedded portion of the fiber can serve as a water reservoir for the exposed portion and/or dangling end portion of the fiber.

According to some embodiments, the process temperature of the compostable polymer is higher than 100° C., in particular higher than 110° C. or even higher than 130° C. The processing temperature to manufacture the artificial turf infill may be up to 180° C., preferably up to 170° C. or up to 155° C.

These high processing temperatures are not harmful to the natural fibers listed above. For example these above described natural fibers are known to survive a vulcanization process at 180° C. Additionally, some of these natural fibers have a relatively low lignin content (<5 wt % of the total fiber). This enables certain natural fibers to be compatible with the high temperature process of up to 180° C.

According to some embodiments, it is envisaged in order to increase the total weight of the artificial turf infill that the filler material has a density of at least 2.0 g/cm³ and comprises any one of the following: barium sulfate, calcium carbonate, china clay, talc, aluminosilicate, and combinations thereof. These fillers may be mined from natural deposits.

According to some embodiments, the artificial turf infill comprises calcium carbonate (chalk) and/or barium sulphate (barite) as filler material. Barium sulphate and calcium carbonate are particularly advantageous, as they have a high density—e.g., calcium carbonate has a density of 2.7 g/cm³ and barium sulphate has a density of between 4.0 and 4.5 g/cm³. They are also relatively cheap materials and may be used to provide a dense infill.

According some embodiments the artificial turf infill comprises calcium carbonate (chalk) as filler material.

According to some preferred embodiments,
the compostable polymer comprises 25% to 49% of the granules by weight, in particular between 40% and 48%,
the filler material comprises 30% to 50% of the granules by weight, in particular between 31% and 48%,
the oil comprises 1% to 8% of the granules by weight, in particular between 2.5% and 4.5%, and
the natural fibers comprise 2% to 30% of the granules by weight, in particular between 7% and 18%.

This composition of the individual components (compostable polymer, filling material, oil and natural fibers) in the weight percentage ranges shown proved to be very promising. The granules manufactured with the described weight percent ranges of the components showed a tensile strength between 1.2 MPa and 6.0 MPa, an elongation at break between 0.9% and 20%, a surface hardness of smaller than Shore A 98 or smaller than Shore D 55 and a density between 1.2 g/cm³ and 1.6 g/cm³. Applicant has further observed that granules comprising natural fibers were less compacted than granules with a comparable composition but without natural fibers after they have been subjected to a compression load test (2 MPa (2 N/mm²) for 1 hour at 65° C.). The granules comprising the natural fibers were evaluated with a pressure test score between 3 and 4, whereas the granules without natural fiber had a pressure test score between 2 and 4. The pressure test evaluation was carried out according to the rating, as is common in the sector: 1=plastified; 2=sticking together; 3=more compacted; 4=slightly compacted; 5=no significant changes to be noticed.

According to some embodiments, the artificial turf infill further comprises a pigment, in particular an inorganic pigment, selected from the group consisting of iron oxide, chrome oxide, titanium oxide, and combinations thereof, wherein the pigment comprises 0.5% to 2.5% of the artificial turf infill by weight, in particular between 0.8% and 1.3%.

The inorganic pigments provide a desired color to the artificial turf infill. For example, iron oxide may be used to provide a brown color, chrome oxide may be used to provide a green color and titanium oxides may be used to cover a wide color spectrum (due to foreign ions). These inorganic pigments may further be beneficial due to their relatively low manufacturing costs. Further, the use of the inorganic pigments further provides opacity, which provides UV stability of the granules.

According to some embodiments, the artificial turf infill further comprises a lubricant selected from the group consisting of stearic acid, sodium glycerine, glycerine, and combinations thereof, wherein the lubricant comprises 0.1% to 0.5% of the artificial turf infill by weight, in particular between 0.2% and 0.3%. Applicant has observed that the use of a lubricant, in particular stearic acid, further increases the softness of the granules and further improved their elasticity. The presence of the lubricant may therefore further increase the robustness of the infill granules against abrasion and against damages induced by multiple freeze-thaw-cycles. Applicant has further observed that the use of the lubricant, in particular stearic acid, reduces or hinders the adhesion of the polymer to the kneader, stirrer or mixer during the manufacture of the granules of the artificial turf infill.

Thus, for example (Example 1), the granules of the artificial turf infill may consist of
25% to 50% by weight of a compostable polymer, in particular between 34% and 49%,
30% to 50% by weight of a filler material, in particular between 31% and 49.7%,
1% to 9% by weight of an oil, in particular between 2.5% and 8%,
0.5% to 2.5% by weight of pigments, in particular between 0.8% and 1.3% and
0.1% to 0.5% by weight of a lubricant, in particular between 0.2% and 0.3%.

Further, for example (Example 2), the granules of the artificial turf infill may consist of
25% to 50% by weight of a compostable polymer, in particular between 34% and 49%,
30% to 50% by weight of a filler material, in particular between 31% and 49.7%,
1% to 9% by weight of an oil, in particular between 2.5% and 8%,
2% to 30% by weight of natural fibers, in particular between 7% and 18%,
0.5% to 2.5% by weight of pigments, in particular between 0.8% and 1.3% and
0.1% to 0.5% by weight of a lubricant, in particular between 0.2% and 0.3%.

According to one of the preferred embodiments,
the compostable polymer is a mixture of a PLA and a PBS and/or PBAT, wherein the mixture of PLA and a PBS and/or PBAT comprises 25% to 45% of the granules by weight, in particular between 34% and 40%,
the natural filler is chalk, wherein the chalk comprises 30% to 50% of the granules by weight, in particular between 40% and 48%,
the oil is an oil comprising an unsaturated synthetic ester, wherein the oil comprises 1% to 5% of the granules by weight, in particular between 2.5% and 4.5%, and
the natural fibers are hemp fibers, wherein the hemp fibers comprise 2% to 30% of the granules by weight, in particular between 7% and 18%.

According to an alternative preferred embodiments,
the compostable polymer is a mixture of a PLA and a PBS and/or PBAT, wherein the mixture of PLA and a PBS and/or PBAT comprises 25% to 50% of the granules by weight, in particular between 40% and 48%,
the natural filler is chalk, wherein the chalk comprises 30% to 50% of the granules by weight, in particular between 31% and 40%,
the oil is an oil comprising an unsaturated synthetic ester, wherein the oil comprises 1% to 5% of the granules by weight, in particular between 2.5% and 4.5%, and
the natural fibers are hemp fibers, wherein the hemp fibers comprise 2% to 30% of the granules by weight, in particular between 7% and 18%.

The mixture of PLA and a PBS and/or PBAT may be a blend of a PLA and a PBS and/or PBAT. The mixture or blend may preferably comprise more PLA than PBS and/or PBAT, e.g., the mixture or blend may comprise 55 wt.-% to 99 wt.-% of PLA and 1 wt.-% to 45 wt.-% of PBS and/or PBAT or 80 wt.-% to 99 wt.-% of PLA and 1 wt.-% to 20 wt.-% of PBS and/or PBAT.

The use of hemp may be beneficial because hemp is naturally resistant to fungi in comparison with e.g., coconut fibers. Hemp also has the benefit of being very skin friendly. Hemp is less abrasive and/or prickly than many other natural fibers such as wood chips or coconut fibers. The use of hemp as an infill material may further be beneficial because it has superior damping and shock absorption properties. A player who falls on an artificial turf with an infill according to an embodiment may in some cases be less likely to be hurt than if the player fell on an artificial turf that had, for example, a predominantly coconut fiber based infill.

This composition of the individual components in the weight percentage ranges shown proved to be very promising. The granules manufactured with the described weight percent ranges of the components showed a tensile strength between 1.2 MPa and 1.6 MPa, an elongation at break between 2% and 5%, a surface hardness of smaller than Shore A 80 and a density between 1.2 g/cm³ and 1.4 g/cm³. Applicant has further observed that granules comprising hemp fibers were less compacted than granules with a comparable composition but without hemp fibers after they have been subjected to a compression load test (as described above). The granules comprising the hemp fibers were evaluated with a pressure test score of 4, whereas the granules without hemp fibers resulted in a pressure test score between 2 and 3.

According to another alternative preferred embodiment,
the compostable polymer is a TPC, a mixture of a TPC and a PBS or a mixture of a TPC and a PHB, wherein the TPC, the mixture of TPC and PLS or the mixture of a TPC and PHB comprises 25% to 45% of the granules by weight, in particular between 34% and 40%,
the natural filler is chalk, wherein the chalk comprises 30% to 50% of the granules by weight, in particular between 40% and 48%,
the oil is an oil comprising an unsaturated synthetic ester, wherein the oil comprises 1% to 5% of the granules by weight, in particular between 2.5% and 4.5%, and
the natural fibers are hemp fibers, wherein the hemp fibers comprise 2% to 30% of the granules by weight, in particular between 7% and 18%.

According to an alternative preferred embodiments,
the compostable polymer is a TPC, a mixture of a TPC and a PLS or a mixture of a TPC and a PHB, wherein the TPC, the mixture of TPC and PLS or the mixture of a TPC and PHB comprises 25% to 50% of the granules by weight, in particular between 40% and 48%,
the natural filler is chalk, wherein the chalk comprises 30% to 50% of the granules by weight, in particular between 31% and 40%,
the oil is an oil comprising an unsaturated synthetic ester, wherein the oil comprises 1% to 5% of the granules by weight, in particular between 2.5% and 4.5%, and
the natural fibers are hemp fibers, wherein the hemp fibers comprise 2% to 30% of the granules by weight, in particular between 7% and 18%.

The compostable polymer may be a TPC or may be a mixture of a TPC and a PBS or a mixture of a TPC and a PHB. The mixture of a TPC and a PBS may be a blend. The mixture of a TPC and a PHB may be a blend. The mixture or blend may preferably comprise more TPC than PBS or PHB, e.g. the mixture or blend may comprise 55 wt.-% to 99 wt.-% of TPC and 1 wt.-% to 45 wt.-% of PBS or PHB, or 80 wt.-% to 99 wt.-% of TPC and 1 wt.-% to 20 wt.-% of PBS or PHB. The beneficial use of hemp is described above and is equally applicable to this embodiment.

This composition of the individual components in the weight percentage ranges shown proved also to be very promising. The granules manufactured with the described weight percent ranges of the components showed a tensile strength between 1.3 MPa and 1.7 MPa, an elongation at break between 7% and 13%, a surface hardness of smaller than Shore A 70 and a density between 1.25 g/cm³ and 1.5 g/cm³. Applicant has further observed that granules comprising hemp fibers were less compacted than granules with a comparable composition but without hemp fibers after they have been subjected to a compression load test (as described above). The granules comprising the hemp fibers were evaluated with a pressure test score of 3, whereas the granules without hemp fibers resulted in a pressure test score between 2 and 3.

For each alternative embodiment it may be beneficial that the artificial turf infill further comprises
an inorganic pigment selected from the group consisting of iron oxide, chrome oxide, titanium oxide, and combinations thereof, wherein the inorganic pigment comprises 0.5% to 2.5% of the artificial turf infill by weight, in particular between 0.8% and 1.3%, and/or
stearic acid as a lubricant, wherein the stearic acid comprises 0.1% to 0.5% of the artificial turf infill by weight, in particular between 0.2% and 0.3%.

Thus, for example (Example 3), the granules of the artificial turf infill may consist of
25% to 50% by weight of a mixture of a PLA and a PBS and/or PBAT, in particular between 34% and 48%,
30% to 50% by weight of chalk, in particular between 31% and 48%,
1% to 5% by weight of an oil comprising an unsaturated synthetic ester, in particular between 2.5% and 4.5%,
2% to 30% by weight of hemp fibers, in particular between 7% and 18%,
0.5% to 2.5% by weight of pigments selected from the group consisting of iron oxide, chrome oxide, titanium oxide, and combinations thereof, in particular between 0.8% and 1.3% and
0.1% to 0.5% by weight of stearic acid, in particular between 0.2% and 0.3%.

Further, for example (Example 4), the granules of the artificial turf infill may consist of
25% to 50% by weight of
   TPC,
   a mixture of a TPC and a PBS or
   a mixture of a TPC and a PHB,
in particular between 34% and 48%,
30% to 50% by weight of chalk, in particular between 31% and 48%,
1% to 5% by weight of an oil comprising an unsaturated synthetic ester, in particular between 2.5% and 4.5%,
2% to 30% by weight of hemp fibers, in particular between 7% and 18%,
0.5% to 2.5% by weight of pigments selected from the group consisting of iron oxide, chrome oxide, titanium oxide, and combinations thereof, in particular between 0.8% and 1.3% and
0.1% to 0.5% by weight of stearic acid, in particular between 0.2% and 0.3%.

According to embodiments, a diameter of the granules of the artificial turf infill is between any one of the following: 0.1 mm and 3.5 mm, 0.3 mm and 3.0 mm, and 0.5 mm and 2.5 mm.

It may be provided here that in each defined diameter range the granules are present with a normal distributed diameter. The normal size distribution of the granules may result in an increase of the bulk density.

According to embodiments, the shape of the granules is round, oblong, cylindrical, in a form of a kidney bean or in the form of a chip or a cookie. The shape of the granules may influence the bulk density and thus the perceived hardness of the turf infill to suit the desired properties. For example, the bulk density may be reduced by an oblong (elongated) shape of the granules (compared to round shapes), as the oblong granules form an interlocking structure when they are spread. The air in the spaces between the granules affects however the perceived hardness of the infill layer, which makes it feel softer.

According to embodiments, the length of the natural fibers is between any one of the following: 0.05 mm and 4.5 mm, 0.1 mm and 3.5 mm, 0.2 mm and 3.5 mm, and 0.2 mm and 2.5 mm.

The length of a natural fiber may thus be longer than the diameter of the granule in which the fiber is embedded. Hence, the fiber may embedded in the granule in a curved or serpentine form, or one end of the fiber may protrude beyond the surface of the granule.

According to embodiments, the granules have a density between 1.2 g/cm³ and 1.5 g/cm³. Further, the granules may have a surface hardness of smaller than Shore A 85, more preferably, smaller than Shore A 82.

In another aspect the invention provides for a method of manufacturing an artificial turf infill. The method comprises mixing multiple components to form a master batch. The multiple components comprise
a compostable polymer selected from the group consisting of polylactic acid (PLA), thermoplastic copolyester elastomer (TPC), polybutylene succinate (PBS), poly(3-hydroxybutyrate-co-3-hydroxyvalerate) (PHBV), polyhydroxybutyrate (PHB), polyhydroxyalkanoate (PHA), polybutylene adipate terephthalate (PBAT), a derivative thereof or a mixture thereof;
a filler material; and
an oil.

The compostable polymer, the filler material and the oil may be the compostable polymer, the filler material and the oil as disclosed above for the granules of the artificial turf infill. The mixing of the multiple components may be performed by a kneading machine, blending machine or in an extruder. The mixing provides that the multiple components are essentially homogeneously distributed in the master batch.

The method further comprises heating the master batch to form a mouldable mass comprising the multiple components. The heating may take place during or after the mixing of the master batch. The master batch may be heated to temperatures between 100° C. and 180° C., in particular between 110° C. and 110° C. or between 130° C. and 155° C.

The method further comprises shaping the master batch into a solid form to provide artificial turf infill. For example, the solid form may be cut, shredded or ground to provide the artificial turf infill. The solid form may be pelletized while leaving the kneading machine, blending machine or the extruder. After the pelletized solid form cools down, the cooled down solid form may be provided as the granule of the artificial turf infill. This granule may be further granulated to provide a desired shape. Alternatively, the solid form may be discharged from the kneading machine, blending machine or the extruder and e.g., shaped as a plate, which is then granulated or shredded. The granulated solid form is then the granule.

According to embodiments, the method further comprises that the multiple components further comprise natural fibers. The natural fibers may be the natural fibers as disclosed above for the artificial turf infill. The natural fibers may be hemp fibers.

According to embodiments, the method further comprises that the shaping comprises pelletizing the heated master batch.

According to embodiments or after the pelletizing step, the method further comprises that the shaping further comprises granulating the solid form. The granulation of the solid form may comprise grinding, cutting and/or shredding.

According to embodiments, the method further comprises adding any one of the following to the master batch:
an inorganic pigment and/or
a lubricant.

The inorganic pigment and the lubricant may be the inorganic pigment and the lubricant as disclosed above for the artificial turf infill.

In another embodiment the method further comprises milling the natural fibers in an oil before adding the natural fibers to the master batch. The oil may comprise an unsaturated ester, in particular an unsaturated synthetic ester. The milling of the natural fibers in the oil may provide several advantages. A large advantage is that the natural fibers are less likely to be ground into very small portions such as dust. Milling them in the oil therefore helps to produce an artificial turf infill with more uniform and intact natural fibers that have been reduced in size. The oil may be the same oil which may be used in producing the granule portion or the polymer portion. The oil therefore fulfills two requirements in this one manufacturing process.

In a further aspect, the invention relates to an artificial turf. The artificial turf comprises an artificial turf carpet, wherein the artificial turf carpet comprises multiple artificial turf fiber tufts and artificial turf infill as described herein for embodiments and examples of the invention, the artificial turf infill being spread between the multiple artificial fiber tufts.

According to one embodiment the artificial turf further comprises further granules, wherein the further granules are selected from the group consisting of microporous zeolite mineral, sand, crushed brick and cork. The artificial turf infill spread between the multiple artificial fiber tufts may be a mixture of the artificial turf infill as described herein for embodiments and examples of the invention and the further granules selected from the group consisting of microporous zeolite mineral, sand, crushed brick and cork.

According to one embodiment the artificial turf further comprises a sprinkler system. The inclusion of a sprinkler system may be beneficial because it may provide for a means of conveniently wetting an artificial turf surface with water. The natural fibers may retain some of the water and may slowly evaporate it. Thereby the artificial turf may remain cool even when exposed to strong sunlight.

In a further aspect, the invention relates to a method of providing, in particular installing, an artificial turf. The method further comprises installing an artificial turf carpet at a use site, wherein the artificial turf carpet comprises multiple artificial turf fiber tufts; and providing the artificial turf by spreading a layer of artificial turf infill as described herein for embodiments and examples of the invention between the multiple artificial turf fiber tufts.

Artificial turf infill may be used to modify an artificial turf carpet to have more earth like properties. For example the artificial turf infill may provide a surface which is able to absorb impacts in a manner similar to real turf.

According to one embodiment the artificial turf infill is mixed with further granules prior to spreading the layer of artificial turf infill between the multiple artificial turf fiber tufts. The further granules may be selected from the group consisting of microporous zeolite mineral, sand, crushed brick and cork.

It is understood that one or more of the aforementioned embodiments of the invention may be combined as long as the combined embodiments are not mutually exclusive.

### BRIEF DESCRIPTION OF THE DRAWINGS

The following embodiments of the invention are explained in greater detail, by way of example only, making reference to the drawings in which:

FIG. 1 illustrates a top view of a granule, made from unfoamed material, of an artificial turf infill;

FIG. 2a illustrates a top view of a granule of an artificial turf infill, wherein the artificial turf infill further comprises a natural fiber;

FIG. 2b illustrates a top view of a granule, made from unfoamed material, of an artificial turf infill, wherein the artificial turf infill further comprises natural fibers;

FIG. 3 illustrates a cross sectional view of a granule, the granule comprising natural fibers, here hemp fibers;

FIG. 4 illustrates a cross sectional view of a granule, the granule comprising natural fibers, here hemp fibers;

FIG. 5 illustrates an example of an artificial turf carpet;

FIG. 6 illustrates an example of artificial turf;

FIG. 7 shows a flow chart that illustrates a method of manufacturing artificial turf infill; and

FIG. 8 shows a flow chart that illustrates a method of manufacturing artificial turf.

### DETAILED DESCRIPTION OF THE DRAWINGS

Like numbered elements in these figures are either equivalent elements or perform the same function. Elements which have been discussed previously will not necessarily be discussed in later figures if the function is equivalent.

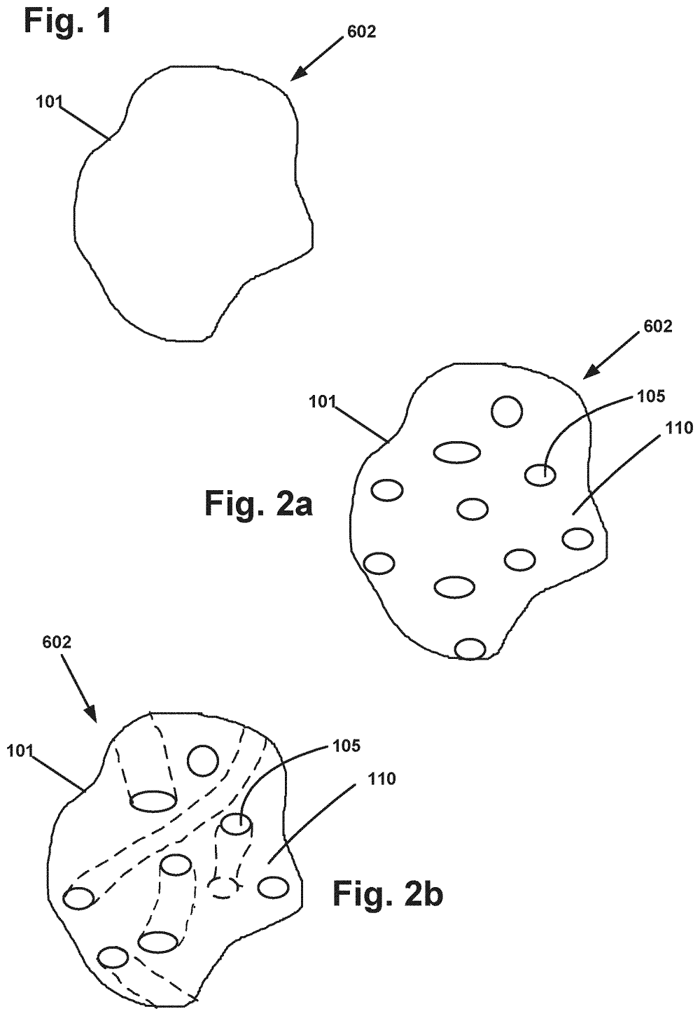

FIGS. 1, 2a, 2b, 3-4 illustrate several examples of granules of the artificial turf infill.

FIG. 1 shows a single artificial turf grain or granule 101 of the artificial turf infill 602. The view shown in FIG. 1 is a top view. The granule 101 could for example be made by providing multiple components and mixing the multiple components to form a homogenous master batch. The multiple components comprise a compostable (biodegradable) polymer, compostable filler material and compostable oil. The compostable polymer may be PLA, TPC, PBS, PHBV, PHB, PHA, PBAT or derivates thereof. The compostable polymer may further be a blend or a mixture of two or more biodegradable polymers selected from the group consisting of PLA, TPC, PBS, PHBV, PHB, PBAT and PHA. The compostable filler material may have a density of at least 2.0 g/cm³ and may be barium sulfate, calcium carbonate, china clay, talc, aluminosilicate or combinations thereof. The compostable oil may comprise an unsaturated ester, in particular an unsaturated synthetic ester, and may be made from renewable resources. The mixing may be performed by a kneading machine, blending machine or in an extruder. During or after the mixing of the master batch, which comprises the multiple components, the master batch is heated to form a mouldable mass, which is shaped into a solid form. The solid form may be pelletized while leaving the kneading machine, blending machine or extruder, and after cooling, forms the granule 101. This granule may be further granulated to provide a desired shape. The solid form may also leave the kneading machine, blending machine or extruder and e.g., be shaped as a plate, which is then granulated or shredded. The granulated solid form is then the granule 101. Applicant has observed that for the artificial turf infill for which the compostable polymer comprises 25% to 50% of the artificial turf infill by weight, in particular between 34% and 48%, the filler material comprises 30% to 50% of the artificial turf infill by weight, in particular between 31% and 49.7%, and the oil comprises 1% to 9% of the artificial turf infill by weight, in particular between 2.5% and 8%, and wherein the artificial turf infill does not comprise any natural fiber, the granules manufactured showed a tensile strength between 0.2 MPa and 11.0 MPa, an elongation at break between 0.1% and 70%, a surface hardness of smaller than Shore A 98 or smaller than Shore D 55 and a density between 1.2 g/cm³ and 1.8 g/cm³. The granules were further evaluated using a compression load test (2 MPa (2 N/mm²) for 1 hour at 65° C.). Hereby, granules comprising a mixture of a PLA and a PBS and/or PBAT, granules comprising a TPC, a mixture of a TPC and a PBS or a mixture of a TPC and a PHB or granules comprising PHB were evaluated with a pressure test score between 2 and 3, whereas the granules comprising PHB resulted in a pressure test score of 4. The pressure test evaluation was carried out according to the rating, as is common in the sector: 1=plastified; 2=sticking together; 3=more compacted; 4=slightly compacted; 5=no significant changes to be noticed.

FIG. 2a and FIG. 2b each show a single artificial turf grain or granule 101 of the artificial turf infill 602, wherein natural fibers 105 are embedded in the granules 101 of the artificial turf infill. The granule 101, as depicted in the FIGS. 2a and 2b, may comprise the same components as the granule of FIG. 1 with natural fibers as an additional component. The natural fibers may be burlap fibers, jute fibers, cotton fibers, wool fibers, hemp fibers, flax fibers, kenaf fibers, nettle fibers, sisal fibers, coconut fibers, walnut fibers, abacá fibers, and combinations thereof. The length of the natural fibers is between any one of the following: 0.05 mm and 4.5 mm, 0.1 mm and 3.5 mm, 0.2 mm and 3.5 mm, and 0.2 mm and 2.5 mm. An advantage of using the natural fibers 105 is that the natural fibers do not heat very quickly and help to isolate other components of the artificial turf from being heated. A further advantage of using the natural fibers 105 is that they absorb water. This may help to make the artificial turf surface seem more realistic and softer and may also have the effect of storing water to reduce the temperature of the playing surface. The fibers, which are completely embedded in the polymer portion 110, are not able to absorb water, however the cost of natural fiber is considerably less than the cost of the polymer portion. In the examples, as shown in the top views of FIGS. 2a and 2b, the natural fibers are hemp fibers. FIG. 2a illustrates that the granules 101 of the artificial turf infill 602 may comprise a polymer portion 110 and the hemp fibers 105 are embedded in the polymer portion. The polymer portion 110 comprises the compostable polymer, the filler material, and the oil. The polymer portion 110 may further comprise a lubricant and/or pigments. As shown in FIGS. 2a and 2b, the hemp fibers are embedded in the polymer portion 110 of the granule 101 and ends of the hemp fibers 105 do not protrude (i.e., dangle) beyond the surface of the granule. A granule having fibers with no dangling ends (i.e., fibers with ends that do not protrude beyond the surface of the granule) is achieved, for example, by granulation during the manufacture of the infill 602. However, as shown in FIG. 2a a portion, here an end, of the fibers may be exposed at the surface of the granule 101. This end portions of the fibers can facilitate water absorption, because they a fully exposed to water or moisture. Water absorbed by the exposed portion of the fibers can further spread into the rest of the fibers, which are embedded in the granule e.g. due to capillary effect. Thus the exposed portions can facilitate water absorption. The exposed portion can further facilitate water evaporation from the fiber as well because an entire surface of the exposed portion is exposed to air. Moreover the embedded portion of the fiber can serve as a water reservoir for the exposed portion of the fiber 105.

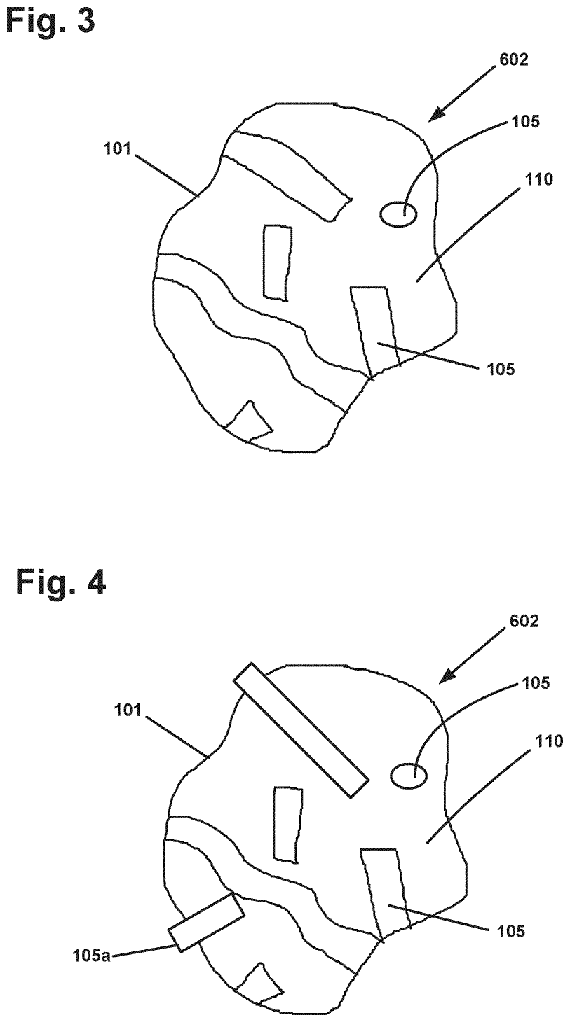

FIG. 3 shows a cross-sectional view of a single artificial turf grain or granule 101 of the artificial turf infill 602, wherein natural fibers 105 are embedded in the granules 101 of the artificial turf infill. The granule 101, as depicted in FIG. 3, may comprise the same components as the granule of FIG. 2a or 2b.

FIG. 4 shows a cross-sectional view of a single artificial turf grain or granule 101 of the artificial turf infill 602, wherein natural fibers 105 are at least partially embedded in the granules 101 of the artificial turf infill. As shown in FIG. 4, some of the natural fibers, in particular hemp fibers, are fully embedded in the polymer portion 110 of the granule 101, and other fibers are partially embedded in the polymer portion 110 of the granule 101. As depicted in FIG. 4 some of the fibers 105 have dangling ends 105a, i.e., ends that protrude beyond the surface of the granule 101. A granule having fibers with dangling ends (i.e., fibers with ends that protrude beyond the surface of the granule) is achieved, for example, by a pelletizing step during the manufacture of the infill 602. The fibers having dangling ends can facilitate water absorption and evaporation. The dangling end of a fiber can absorb water or moisture in an effective way because an entire surface area (or substantial portion of a surface area) of the dangling end can be in full contact with water or moisture. The same principle is valid for evaporation of water, because an entire surface area (or substantial portion of the surface area) of the dangling end is in contact with air. Moreover the embedded portions of the fibers having dangling ends can act as reservoirs of water, e.g. due to capillary effect.

The granules shown in FIGS. 2a, 2b, 3 and 4 show artificial turf infill for which the compostable polymer comprises 25% to 50% of the artificial turf infill by weight, in particular between 25% to 46% of the artificial turf infill by weight or in particular between 34% and 40%, the filler material comprises 30% to 50% of the artificial turf infill by weight, in particular between 31% and 48%, the oil comprises 1% to 8% of the artificial turf infill by weight, in particular between 2.5% and 4.5%, and the natural fibers comprise 2% to 30% of the artificial turf infill by weight, in particular between 7% and 18%. These manufactured granules showed a tensile strength between 1.2 MPa and 6.0 MPa, an elongation at break between 0.9% and 20%, a surface hardness of smaller than Shore A 98 or smaller than Shore D 55 and a density between 1.2 g/cm³ and 1.6 g/cm³. Hereby, granules comprising a mixture of a PLA and a PBS and/or PBAT, granules comprising a TPC, a mixture of a TPC and a PBS or a mixture of a TPC and a PBS or granules comprising a PBS showed a tensile strength between 1.3 MPa and 5.0 MPa, an elongation at break between 2.5% and 12%, a surface hardness of smaller than Shore A 82 and a density between 1.2 g/cm³ and 1.4 g/cm³. Granules comprising PHB showed a tensile strength between 1.6 MPa and 2.5 MPa, an elongation at break between 0.8% and 1.2%, a surface hardness of smaller than Shore D 56 and a density between 1.4 g/cm³ and 1.6 g/cm³. The granules were further evaluated using a compression load test (2 MPa (2 N/mm²) for 1 hour at 65° C.). Here, the granules comprising a mixture of a PLA and a PBS and/or PBAT and granules comprising PHB resulted in a pressure test score of 4 and the granules comprising a TPC, a mixture of a TPC and a PBS or a mixture of a TPC and a PBS resulted in a pressure test score of 3.

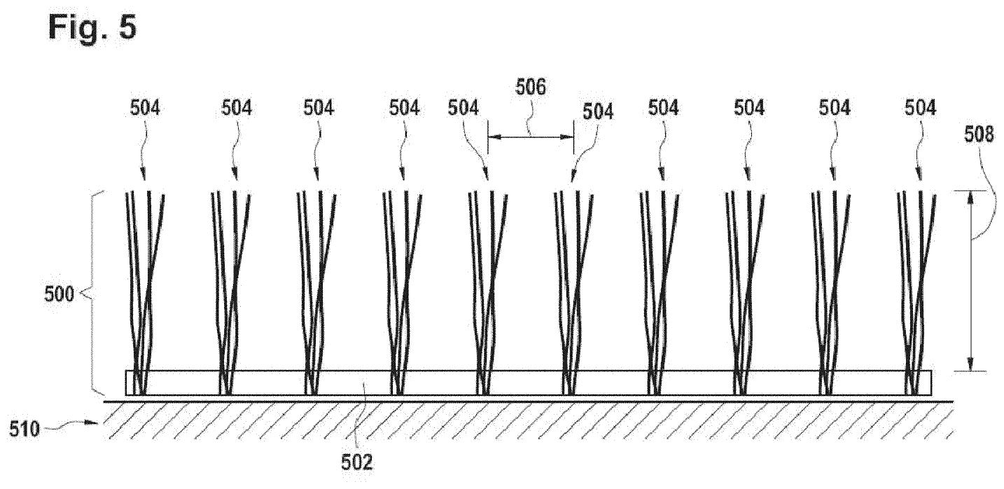

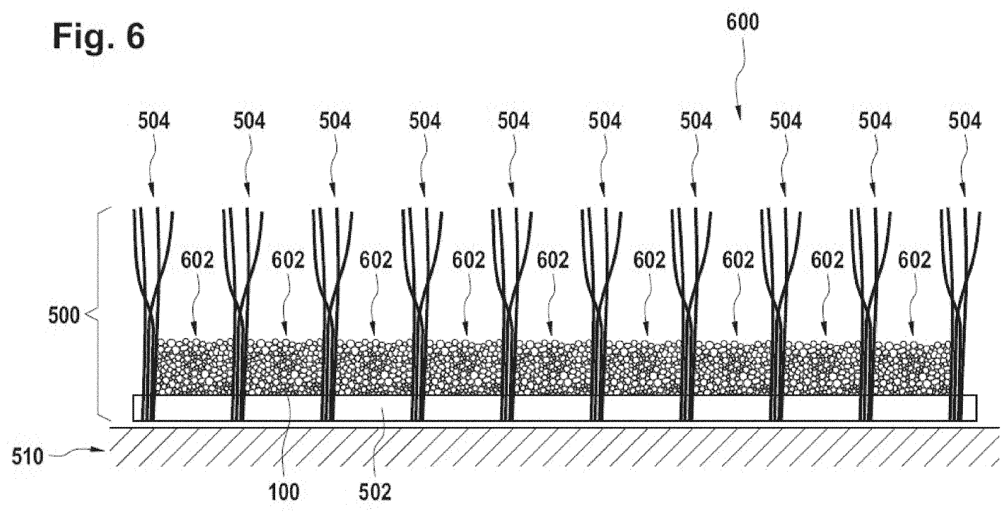

FIGS. 5 and 6 illustrate the manufacture of an artificial turf using an artificial turf carpet and artificial turf infill. In FIG. 5 an artificial turf carpet 500 can be seen. The artificial turf carpet 500 comprises a backing 502. The artificial turf carpet 500 shown in FIG. 5 is a tufted artificial turf carpet in this example. The artificial turf carpet is formed by artificial turf fiber tufts 504 that are tufted into the backing 502. The artificial turf fiber tufts 504 are tufted in rows. There is row spacing 506 between adjacent rows of tufts. The artificial turf fiber tufts 504 also extend a distance above the backing 502. The distance that the fibers 504 extend above the backing 502 is the pile height 508. In FIG. 5 it can be seen that the artificial turf carpet 500 has been installed by placing or attaching it to the ground 510 or a floor. To manufacture the artificial turf, the artificial turf infill made up of grains or granules such as is shown in FIGS. 1 to 4 are spread out on the surface and distributed between the artificial turf fiber tufts 504. FIG. 6 shows the artificial turf carpet 500 after the artificial turf infill 602 has been spread out and distributed between the artificial turf fiber tufts 504. It can be seen that the artificial turf infill 602 is a granulate made up of individual grains 100 or granules such as is depicted in FIGS. 1 to 4.

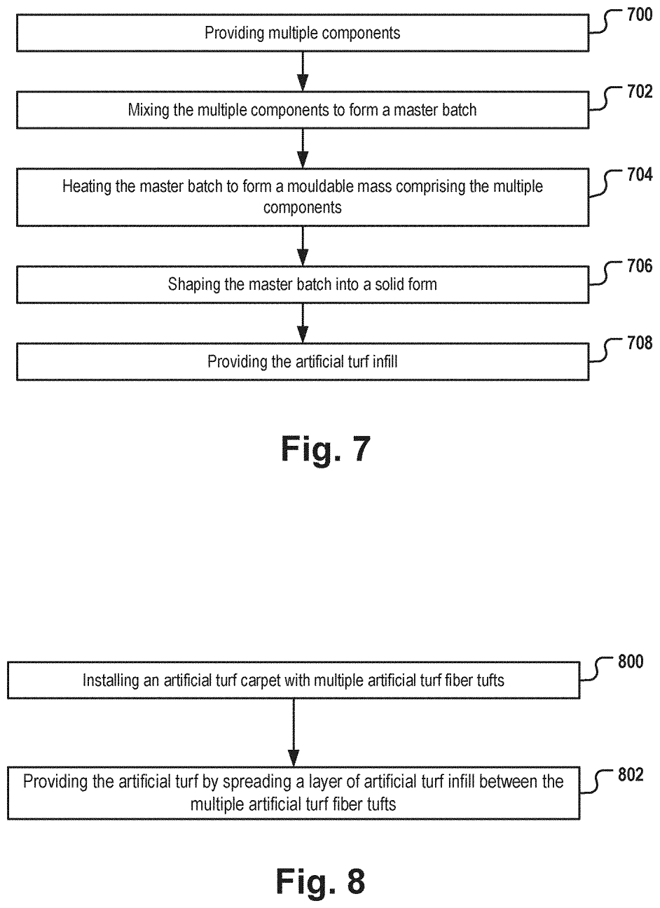

FIG. 7 shows a flowchart that illustrates a method of manufacturing artificial turf infill 602 such as is depicted in FIGS. 1-4. First in step 700 multiple components are provided. The multiple components comprise at least a compostable polymer, filler material and an oil. Next in step 702 the multiple components are mixed to form a master batch. Next in step 704 the master batch is heated to form a mouldable mass comprising the multiple components. Steps 702 and 704 may in some cases be performed at the same time. After the master batch has been mixed and heated the master batch may be formed 706 into a solid form. The solid form may be cut, shredded or ground to provide 708 the artificial turf infill. The artificial turf infill may be then used to manufacture an artificial turf as is illustrated in FIG. 8.

FIG. 8 shows a flowchart, which illustrates a method of manufacturing artificial turf 600 such as depicted in FIG. 6. First in step 800 an artificial turf carpet 500 is installed. The artificial turf carpet comprises multiple artificial turf fiber tufts 504. Next in step 802, the artificial turf 600 is provided by spreading a layer of artificial turf infill 602 between the multiple artificial turf fiber tufts 504. The artificial turf infill 602 comprises the granules 101, as illustrated in one of the FIGS. 1 to 4.

### LIST OF REFERENCE NUMERALS

101 granule
105 natural fiber
110 polymer portion
500 artificial turf carpet
502 backing
504 artificial turf fiber tufts
506 row spacing
508 pile height
510 ground or floor
600 artificial turf
602 artificial turf infill
700 providing multiple components
702 mixing the multiple components to form a master batch
704 heating the master batch to form a mouldable mass comprising the multiple components
706 shaping the master batch into a solid form
708 providing the artificial turf infill
800 installing an artificial turf carpet with multiple artificial turf fiber tufts
802 providing the artificial turf by spreading a layer of artificial turf infill between the multiple artificial turf fiber tufts

1. Artificial turf infill for an artificial turf, wherein the artificial turf infill consists of granules, wherein the granules are made from unfoamed material, wherein the granules comprise
a compostable polymer selected from the group consisting of polylactic acid (PLA), thermoplastic copolyester elastomer (TPC), polybutylene succinate (PBS), poly(3-hydroxybutyrate-co-3-hydroxyvalerate) (PHBV), polyhydroxybutyrate (PHB), polyhydroxyalkanoate (PHA), polybutylene adipate terephthalate (PBAT), a derivative thereof or a mixture thereof;
a filler material; and
an oil.

2. The artificial turf infill of claim 1, wherein the granules of the artificial turf infill are free of any UV stabilizers, in particular hindered amine light stabilizer (HALS), UV absorbers and radical scavengers.

3. The artificial turf infill of claim 1, wherein the granules of the artificial turf infill further comprises natural fibers selected from the group consisting of burlap fibers, jute fibers, cotton fibers, wool fibers, hemp fibers, flax fibers, kenaf fibers, nettle fibers, sisal fibers, coconut fibers, walnut fibers, abacá fibers, and combinations thereof.

4. The artificial turf infill of claim 3, wherein the natural fibers are selected from the group consisting of jute fibers, hemp fibers, kenaf fibers, sisal fibers, coconut fibers, walnut fibers, abacá fibers, and combinations thereof, wherein each of these fibers has a lignin content higher than 8.9 wt %.

5. The artificial turf infill of claim 1, wherein the granules of the artificial turf infill further comprises natural fibers, the natural fibers being hemp fibers.

6. The artificial turf infill of claim 1, wherein the granules of the artificial turf infill have a density of at least 1.0 g/cm³.

7. The artificial turf infill of claim 1, wherein the natural fibers are at least partially embedded in the granules of the artificial turf infill.

8. The artificial turf infill of claim 1, wherein the oil comprises an unsaturated ester, in particular an unsaturated synthetic ester.

9. The artificial turf infill of claim 1, wherein the oil is made from renewable resources.

10. The artificial turf infill of claim 1, wherein the filler material has a density of at least 2.0 g/cm³ and comprises any one of the following: barium sulfate, calcium carbonate, china clay, talc, aluminosilicate, and combinations thereof.

11. The artificial turf infill of claim 1, wherein
the compostable polymer comprises 25% to 50% of the granules by weight,
the filler material comprises 30% to 50% of the granules by weight,
the oil comprises 1% to 9% of the granules by weight.

12. The artificial turf infill of claim 11, wherein the granules of the artificial turf infill further comprises natural fibers, in particular hemp fibers, wherein the natural fibers comprise 2% to 30% of the granules by weight, in particular between 7% and 18%.

13. The artificial turf infill of claim 1, wherein a process temperature of the compostable polymer is higher than 100° C., in particular higher than 110° C.

14. The artificial turf infill of claim 1, wherein the granules of the artificial turf infill further comprises a pigment, in particular an inorganic pigment, selected from the group consisting of iron oxide, chrome oxide, titanium oxide, and combinations thereof, wherein the pigment comprises 0.5% to 2.5% of the granules by weight, in particular between 0.8% and 1.3%.

15. The artificial turf infill of claim 1, wherein the granules of the artificial turf infill further comprises a lubricant selected from the group consisting of stearic acid, sodium glycerine, glycerine, and combinations thereof, wherein the lubricant comprises 0.1% to 0.5% of the granules by weight, in particular between 0.2% and 0.3%.

16. The artificial turf infill of claim 1, wherein
the compostable polymer is a mixture of a PLA and a PBS, wherein the mixture of PLA and a PBS comprises 25% to 45% of the granules by weight, in particular between 34% and 40%,
the natural filler is chalk, wherein the chalk comprises 30% to 50% of the granules by weight, in particular between 40% and 48%,
the oil is an oil comprising an unsaturated synthetic ester, wherein the oil comprises 1% to 5% of the granules by weight, in particular between 2.5% and 4.5%, and
the natural fibers are hemp fibers, wherein the hemp fibers comprise 2% to 30% of the granules by weight, in particular between 7% and 18%.

17. The artificial turf infill of claim 1, wherein
the compostable polymer is a mixture of a PLA and a PBS and/or PBAT, wherein the mixture of PLA and a PBS and/or PBAT comprises 25% to 50% of the granules by weight, in particular between 40% and 48%,
the natural filler is chalk, wherein the chalk comprises 30% to 50% of the granules by weight, in particular between 31% and 40%,
the oil is an oil comprising an unsaturated synthetic ester, wherein the oil comprises 1% to 5% of the granules by weight, in particular between 2.5% and 4.5%, and
the natural fibers are hemp fibers, wherein the hemp fibers comprise 2% to 30% of the granules by weight, in particular between 7% and 18%.

18. The artificial turf infill of claim 1, wherein
the compostable polymer is a TPC, a mixture of a TPC and a PLS or a mixture of a TPC and a PHB, wherein the TPC, the mixture of TPC and PLS or the mixture of a TPC and PHB comprises 25% to 45% of the granules by weight, in particular between 34% and 40%,
the natural filler is chalk, wherein the chalk comprises 30% to 50% of the granules by weight, in particular between 40% and 48%,
the oil is an oil comprising an unsaturated synthetic ester, wherein the oil comprises 1% to 5% of the granules by weight, in particular between 2.5% and 4.5%, and
the natural fibers are hemp fibers, wherein the hemp fibers comprise 2% to 30% of the granules by weight, in particular between 7% and 18%.

19. The artificial turf infill of claim 1, wherein
the compostable polymer is a TPC, a mixture of a TPC and a PLS or a mixture of a TPC and a PHB, wherein the TPC, the mixture of TPC and PLS or the mixture of a TPC and PHB comprises 25% to 50% of the granules by weight, in particular between 40% and 48%,
the natural filler is chalk, wherein the chalk comprises 30% to 50% of the granules by weight, in particular between 31% and 40%,
the oil is an oil comprising an unsaturated synthetic ester, wherein the oil comprises 1% to 5% of the granules by weight, in particular between 2.5% and 4.5%, and
the natural fibers are hemp fibers, wherein the hemp fibers comprise 2% to 30% of the granules by weight, in particular between 7% and 18%.

20. The artificial turf infill of claim 16, wherein the granules of the artificial turf infill further comprises
an inorganic pigment selected from the group consisting of iron oxide, chrome oxide, titanium oxide, and combinations thereof, wherein the inorganic pigment comprises 0.5% to 2.5% of the granules by weight, in particular between 0.8% and 1.3%, and/or
stearic acid as a lubricant, wherein the stearic acid comprises 0.1% to 0.5% of the granules by weight, in particular between 0.2% and 0.3%.

21-32. (canceled)
